(19) United States
(12) Patent Application Publication
(10) Pub. No.: US 2016/0032879 A1
(43) Pub. Date: Feb. 4, 2016

(54) High-Pressure Pump, in Particular Plug-In Pump, for a Fuel System for an Internal Combustion Engine

(71) Applicant: ROBERT BOSCH GMBH, Stuttgart (DE)

(72) Inventors: Siamend Flo, Schwieberdingen (DE); Stefan Pfuhl, Markgroeningen (DE); Tamim Latif, Stuttgart (DE); Peter Andretzky, Erlangen (DE)

(21) Appl. No.: 14/777,062

(22) PCT Filed: Jan. 14, 2014
(86) PCT No.: PCT/EP2014/050527

§ 371 Date: Sep. 15, 2015

(30) Foreign Application Priority Data
Mar. 15, 2013 (DE) 10 2013 204 549.2

(51) Int. Cl. F02M 59/48; F04B 53/16; F04B 53/22

(52) U.S. Cl. CPC F02M 59/48; F04B 53/22; F04B 53/16

(57) ABSTRACT

A high-pressure pump, in particular a plug-in pump, for a fuel system of an internal combustion engine includes a housing, and a flange that is rigidly arranged on the housing. The flange is formed from at least two parts. The pump defines a groove-shaped receiving area, and a radially inward region of the flange part is received in the receiving area. The at least two parts of the flange are held on the housing via at least one of a caulked joint and a press connection.

### STATE OF THE ART

The invention relates to a high-pressure pump according to the preamble of claim 1, and to a flange part according to the dependent claims.

Fuel systems for internal combustion engines which comprise, among other things, a high-pressure fuel pump for direct petrol injection, for example, are known from the market. A quantity of fuel needed at any given time can thereby be delivered into a fuel accumulator or a fuel distributor distributing rail at the particular pressure required. Such high-pressure fuel pumps are designed as unit injection pumps, for example. Here a housing of the high-pressure fuel pump is bolted to a cylinder head of the internal combustion engine by way of a flange (“pump flange”). The design principle means that the connection between the flange and the housing is exposed to high mechanical stresses as a result of compressive forces, vibrations and bolt clamping forces.

### DISCLOSURE OF THE INVENTION

The fundamental problem addressed by the invention is solved by a high-pressure pump as claimed in claim 1, and by a flange part as claimed in the coordinated claims. Advantageous developments are specified in dependent claims. Features important for the invention are furthermore contained in the following description and in the drawings, the features possibly being important for the invention both in isolation and in various combinations, without further attention being explicitly drawn to this.

The invention affords the advantage that a flange can be arranged on a housing of a high-pressure fuel pump (“high-pressure pump”) by means of calking to produce a positive interlock or non-positively by means of a press-fit, in either case instead of a cohesive material joint. A welded connection between the flange and the housing is not necessary. The absence of welding eliminates any introduction of thermal energy and a resulting change in grain structure in a material of the welded components. At the same time, this reduces unwanted deformations of the flange or the housing because of changes in grain structure. Moreover, a series of assembly operations in the manufacture of the high-pressure pump can be made more flexible, which may yield scope for manufacturing rationalization and cost savings. Furthermore, the inventive calking or press-fitting of flange parts to the housing of the high-pressure pump avoids any dirt contamination, as is possible in a welding process, for example, due to due welding spatter and smoke. In addition, elimination of the welded connection may likewise allow the flange to be produced inexpensively and with relatively low weight from some material other than high-grade steel.

The flange according to the invention having at least two parts furthermore has the advantage over a one-part design that a comparatively low material blanking wastage can be achieved in the manufacture of the flange parts by means of punching. This is possible because in the case of the flange according to the invention having at least two parts each of the flange parts has only one cutout, for example a semi-circular cutout. This allows an optimum arrangement of a flange profile on a material strip during stamping. Furthermore, no additional connecting elements are necessary for arranging the flange parts on the housing of the high-pressure pump. Such connecting elements might be studs, for example. Accordingly, the positioning accuracy required between the flange parts and the housing of the high-pressure pumps is relatively low, since no holes need to align with one another for pressing in said studs. In the same way, additional holes on the housing for pressing in the studs are eliminated. A further advantage is that the flange parts can be offered up with some play before calking to the housing, so that if necessary component tolerances can be compensated for.

The invention relates to a high-pressure pump, in particular a unit injection pump, for an internal combustion engine, wherein the high-pressure pump comprises a housing and a flange rigidly arranged on the housing. According to the invention the flange is of at least two-part design, wherein the high-pressure pump has a groove-like seating area (“groove”), in which a radially inward area of the flange parts is seated. Here the flange parts are held on the housing by a calked connection and/or a press-fit connection.

In particular, a welded connection for arranging the flange parts on the housing can be dispensed with, thereby eliminating the specific disadvantages associated with this.

In one development of the high-pressure pump the flange parts have cutouts, which are arranged on the flange parts in such a way that in their fitted position the cutouts of the flange parts are partially covered by the groove, a material of the housing being calked in the cutouts. This represents an simple and at the same time inexpensive way of creating space for the material changes that ensue due to calking.

At the same time the cutouts may be designed as circular holes. Circular holes are especially easy and cost effective to produce in the course of the punching process, thereby making the high-pressure pump less expensive to produce.

In a further development of the high-pressure pump the radially inward areas of the flange parts comprise portions which have a greater material thickness and/or a stamped relief different from the areas situated to the side of them. The flange parts are pressed into the groove by means of these portions. These portions allow the press-fitting forces to be greatly reduced, since the contact area between the flange parts on the one hand and the housing on the other is reduced or even minimized and the flange parts, moreover, are substantially more elastic in the area of said portions. Cost-intensive finishing such as grinding, for example, can thereby be dispensed with. The shape, position and number of portions can be chosen to suit the requirements.

The housing of the high-pressure pump is generally made of high-grade steel in order to afford adequate protection against corrosion when in contact with fuel containing ethanol. Since according to the invention a connection between the flange and the housing manages without a welded connection, the flange can therefore advantageously be produced from a material different from that of the housing.

For example, the housing and the flange may be produced from different high-grade steels. In particular, a less expensive high-grade steel may be used for the flange part, so that material costs can be correspondingly reduced. It is not absolutely essential here that the high-grade steel have properties that make it weldable.

The invention also relates to a flange part for the high-pressure pump which has at least one of the features according to the invention described above. Accordingly, the flange part(s) has/have the advantages described above.

In one development of the flange part it is produced from aluminum or from an aluminum alloy or from steel. Alternatives to high-grade steel as the material for the flange part are thereby described, making it possible to rationalize and reduce the costs of manufacturing the high-pressure pump. This is possible, in particular, because the flange is not connected to the housing by means of a welded connection.

Furthermore, the flange part may be produced by punching and/or stamping. Known embodiments of flanges are generally of one-part design and therefore have a circular hole at their center, which serves for connecting the flange to the housing of the high-pressure pump. In the flange designed according to the invention having at least two parts, each flange part has only one, for example semi-circular, cutout. As a result it is possible to arrange the flange parts on the material strip in way that is especially favorable for the punching process, resulting in a reduced material blanking wastage. This affords corresponding cost savings.

Advantageous exemplary embodiments of the invention are explained below with reference to the drawing, in which:

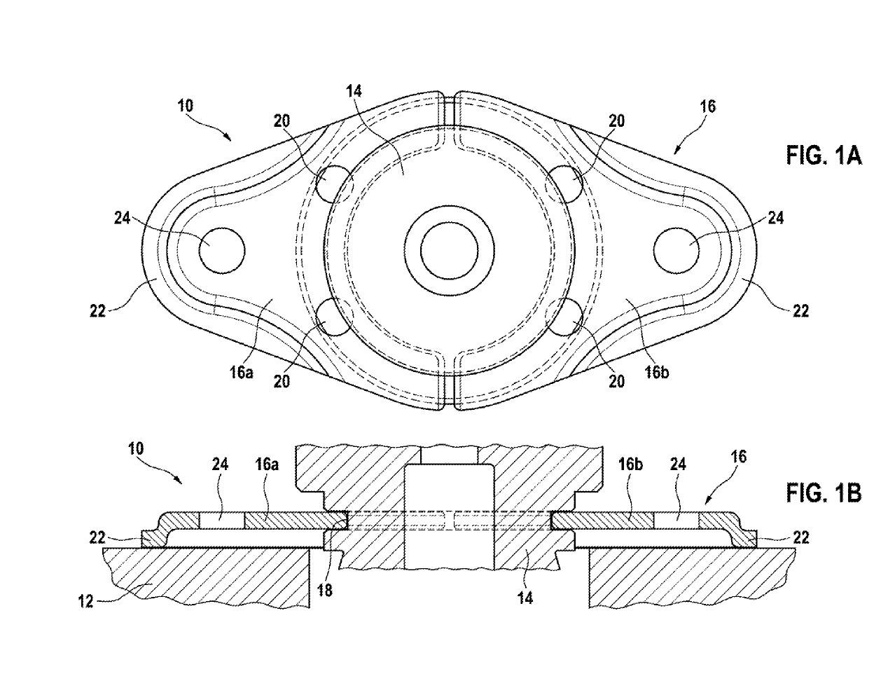

FIG. 1A shows a first embodiment of a high-pressure pump in a view from below;

FIG. 1B shows the first embodiment of the high-pressure pump in FIG. 1A in a sectional side view;

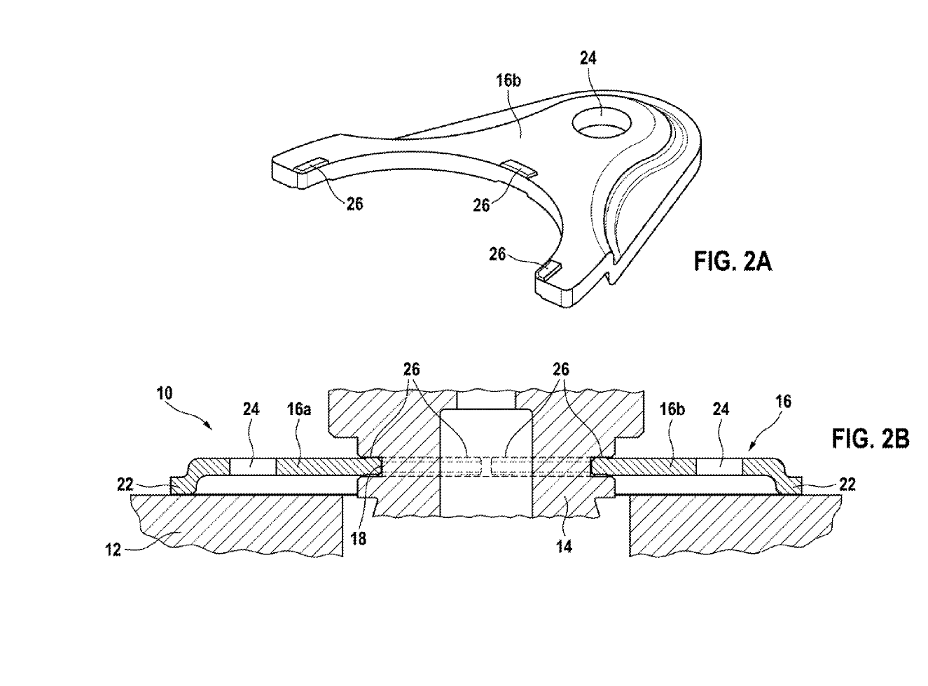

FIG. 2A shows a perspective representation of a flange part for a second embodiment of the high-pressure pump;

FIG. 2B shows the second embodiment of the high-pressure pump with flange parts corresponding to FIG. 2A in a sectional side view; and

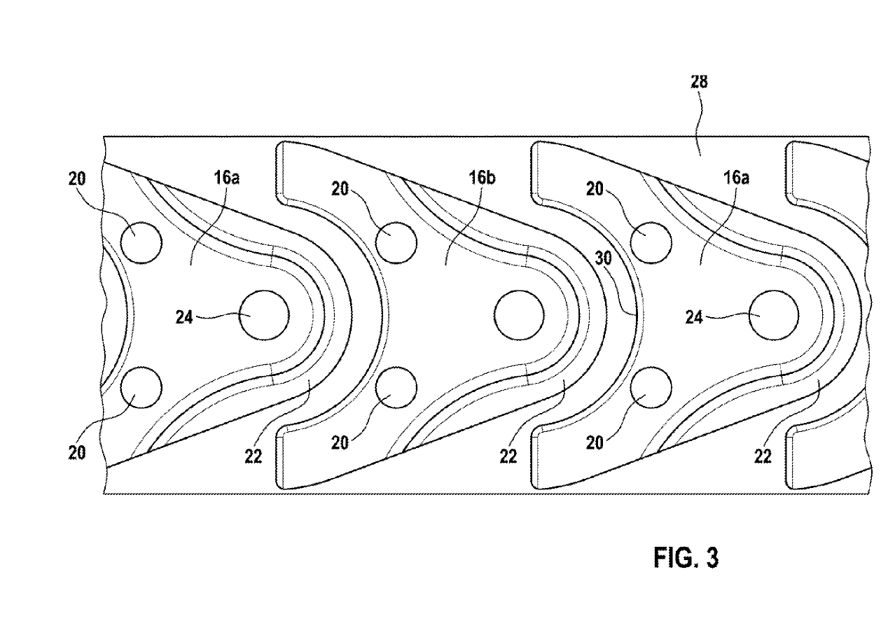

FIG. 3 shows a diagrammatic top view of a material strip for producing flange parts with finished parts arranged therein.

The same reference numerals are used for functionally equivalent elements and sizes in all figures and in different embodiments.

FIGS. 1A and 1B show a first and a second view of a high-pressure pump 10, designed as a unit injection pump, for a fuel system for an internal combustion engine (not shown). FIG. 1A represents an “underside” of the high-pressure pump 10, which with the high-pressure pump 10 in its fitted state faces an attachment structure 12 (see FIG. 1B) of the internal combustion engine. The high-pressure pump 10 comprises a housing 14 and in this case two similar flange parts 16a and 16b.

The two flange parts 16a and 16b together form a flange 16 of the high-pressure pump 10 rigidly arranged on the housing 14. For this purpose the high-pressure pump 10 has a groove-like seating area 18 (“groove”) (see FIG. 1B). A radially inward area of each of the flange parts 16a and 16b is seated in the groove-like seating area 18. The flange parts 16a and 16b each have two cutouts 20, which in this case are designed as circular holes. The cutouts 20 are arranged on the flange parts 16a and 16b in such a way that in their fitted position the cutouts 20 of the flange parts 16a and 16b are partially covered by the groove. Here a material of the housing 14 is calked in the cutouts (“calked connection”).

The flange parts 16a and 16b in FIGS. 1A and 1B are of similar design to one another, that is to say they are mirror-symmetrical about a vertical center line not represented in FIGS. 1A and 1B. In this case the flange parts 16a and 16b are produced by means of punching and stamping. On the left-hand and right-hand areas respectively in FIGS. 1A and 1B the flange parts 16a and 16b have edge portions 22, which have been raised from the remaining areas of the flange parts 16a and 16b by means of a stamping process and therefore afford a three-dimensional geometry of the flange parts 16 and 16b. In particular, the flange parts 16a and 16b are stiffened by the edge portions 22, resulting in greater strength. In this case each of the flange parts 16a and 16b has a circular fixing hole 24. The fixing holes 24 allow the flange parts 16a and 16b and hence the high-pressure pump 10 to be bolted to the attachment structure 12. The bolts needed for this purpose, however, are not represented in FIG. 1A and FIG. 1B.

FIG. 1B shows the arrangement of the high-pressure pump 10 according to FIG. 1A in a partial sectional view, for this purpose tilted by 90°. In FIG. 1B the attachment structure 12 and the groove-like seating area 18 are particularly visible. The groove-like seating area 18 is arranged running around the radial circumference on a radially outer area of the housing 14.

It can be seen how the radially inward area of the flange parts 16a and 16b is seated in the groove-like seating area 18. Since material portions of the housing 14 which enclose the groove-like seating area 18 in an area of the cutouts 20 are calked into the cutouts 20, the flange 16 or the two flange parts 16a and 16b can be rigidly connected to the groove-like seating area 18 and to the housing 14. It will be obvious that, in a departure from the example in FIGS. 1A and 1B, the cutouts 20 may be arranged on the flange parts 16a and 16b in virtually any number, arrangement and shape.

FIG. 1B represents the housing 14 of the high-pressure pump 10 solely in an area of the flange parts 16a and 16b. Otherwise, however, the embodiment of the high-pressure pump 10 according to FIGS. 1A and 1B corresponds to the usual embodiments of high-pressure pumps which are designed as piston pumps, in particular as unit injection pumps.

The flange parts 16a and 16b are fitted to the housing 14, for example, by means of the following steps: in a first step the two flange parts 16a and 16b are offered up to the groove-like area 18 in a defined position. In a second step a material of the housing 14 is calked into the cutouts provided for this purpose by means of circular calking. At least two cutouts 20 are preferably used for each flange part 16a or 16b, in order to prevent a radial shifting and/or a tangential twisting of the flange parts 16a and 16b relative to the housing 14. Here the cutouts 20 coincide only partially with groove-like seating area 18. As a result, the groove-like seating area 18 can be designed with a relatively small radial depth, thereby facilitating any machining required in manufacturing the housing 14. FIGS. 1A and 1B describe a substantially positively interlocking connection between the housing 14 and the flange parts 16a and 16b.

FIGS. 2A and 2B show an alternative embodiment of the flange parts 16a and 16b and the high-pressure pump 10 to those in FIGS. 1A and 1B. FIG. 2A represents a perspective view of the flange part 16b.

Here in a radially inward area the flange part 16b comprises three portions 20 which have a greater material thickness or a stamped relief different from the areas situated adjacent to them. The two flange parts 16a and 16b are of similar design also in FIGS. 2A and 2B.

The two flange parts 16a and 16b are pressed into the radially circumferential groove-like seating area 18 (“press-fit connection”) by means of the portions 26. This correspondingly results in at least three radially inward areas, which serve to hold the flange parts 16a and 16b to the housing 14. A welded connection for fixing the flange parts 16a and 16b to the housing 14 is not necessary in FIGS. 2A and 2B, or in FIGS. 1A and 1B either.

It will be obvious that, in a departure from the example in FIGS. 2A and 2B, the cutouts 26 may be arranged on the flange parts 16a and 16b in virtually any number, arrangement and shape. In addition, it is feasible to arrange elements comparable the portions 26 in an area of the groove-like seating area 18 of the housing 14 rather than on the flange parts 16a and 16b. This is not shown in FIGS. 2A and 2B, however.

In this case the housing 14 of the high-pressure pump 10 is produced from a relatively high-cost, high-grade steel, which allows the high-pressure pump 10 to be operated, free from corrosion, with a fuel containing ethanol. The two flange parts 16a and 16b, by contrast, are produced from a different and comparatively inexpensive high-grade steel. Alternatively it is also possible to produce the flange parts 16a and 16b from aluminum or from an aluminum alloy or also from steel. As in FIGS. 1A and 1B, the flange parts 16a and 16b according to FIGS. 2A and 2B are also produced by punching and/or stamping.

For the embodiment of the high-pressure pump 10 according to FIGS. 2A and 2B the flange parts 16a and 16b are fitted to the housing 14 by means of press-fitting, that is in particular using the portions 26 described above. The required press-fitting forces are relatively small, because the sum of the contact forces (pressing zones) between the flange parts 16a and 16b or the portions 26 and the housing 14 of the high-pressure pump 10 are also relatively small. Moreover, their design makes the flange parts 16a and 16b relatively elastic in the area of the portions 26. Reducing the press-fitting forces in this way may possibly obviate the need for costly finishing work, for example by means of grinding. FIGS. 2A and 2B describe a substantially non-positive connection between the housing 14 and the flange parts 16a and 16b.

FIG. 3 shows a detail from a diagrammatically represented material strip 28 for producing flange parts 16a and 16b with already punched and stamped flange parts 16a and 16b arranged therein. Flange parts 16a and 16b can be continuously punched and stamped out of the material strip 28. Here two complete flange parts 16a and 16b are represented.

It will be seen that the flange parts 16a and 16b are arranged continuously on the material strip 28, the arrangement being especially optimal. In particular, the edge portions 22 of each flange part 16a and 16b may be arranged relatively closely adjacent to a semi-circular cutout 30 of a flange part 16b or 16a arranged adjacently on the material strip 28. This affords an especially low material blanking wastage, making it possible to reduce the manufacturing costs of the flange parts 16a and 16b and of the high-pressure pump 10.

1. A high-pressure pump for a fuel system of an internal combustion engine, comprising:
a housing; and
a flange that is rigidly arranged on the housing, and that formed from at least two parts,
wherein:
the high-pressure pump defines a seating area that includes a groove;
a radially inward area of the at least two parts of the flange is seated in the seating area; and
the at least two parts of the flange are held on the housing by at least one of a calked connection and a press-fit connection.

2. The high-pressure pump as claimed in claim 1, wherein:
the at least two of the flange define cutouts, arranged in such that, when the flange is in a fitted position, the cutouts are partially covered by the groove, and
a material of the housing is calked in the cutouts.

3. The high-pressure pump as claimed in claim 2, wherein the cutouts are circular holes.

4. The high-pressure pump as claimed in claim 1, wherein:
the radially inward areas of at least two parts of the flange include portions which have at least one of a greater material thickness and a stamped relief different from areas situated beside the radially inward areas, and
the portions are configured to press the at least two parts of the flange into the groove.

5. The high-pressure pump as claimed in claim 1, wherein the housing and the flange are include different high-grade steels.

6. A flange part for a high-pressure pump, comprising:
at least two parts that define a radially inward area configured to be received in a groove of a seating area of a housing for a high-pressure pump such that the flange is rigidly arranged on the housing;
wherein the at least two parts are configured to be held on the housing by at least one of a caulked connection and a press-fit connection.

7. The flange part as claimed in claim 6, wherein the flange part is formed from aluminum or from an aluminum alloy or from steel.

8. The flange part as claimed in claim 6 wherein the flange part is formed by at least one of punching and stamping.
